(19) United States
(12) Patent Application Publication
(10) Pub. No.: US 2008/0094544 A1
(43) Pub. Date: Apr. 24, 2008

(54) SURFACE MODIFICATION METHOD FOR POLARIZER, METHOD OF MANUFACTURING POLARIZER, POLARIZER, POLARIZING PLATE, IMAGE DISPLAY APPARATUS, LIQUID CRYSTAL PANEL, AND LIQUID CRYSTAL DISPLAY

(75) Inventors: Masahiro YAEGASHI, Ibaraki-shi (JP); Seiji UMEMOTO, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/838,461

(22) Filed: Aug. 14, 2007

(30) Foreign Application Priority Data
Oct. 20, 2006 (JP) 2006-285746

(51) Int. Cl. G21G 5/00; G02F 1/1335

(52) U.S. Cl. 349/96; 250/492.1

(57) ABSTRACT

A surface modification method for a polarizer, a method of manufacturing a polarizer, a polarizer, a polarizing plate, an image display apparatus, and a liquid crystal panel, and a liquid crystal display. The surface modification method according to the present invention includes the step of: irradiating at least one surface of the polarizer with vacuum ultraviolet light.

### CROSS-REFERENCE TO RELATED APPLICATION

The present patent application claims priority based on prior-filed Japanese Patent Application No. 2006-285746 (filing date: Oct. 20, 2006).

### BACKGROUND OF THE INVENTION

1. Field of the Invention

The present invention relates to a surface modification method for a polarizer, a method of manufacturing a polarizer, a polarizer, a polarizing plate, an image display apparatus, a liquid crystal panel, and a liquid crystal display.

2. Description of the Related Art

Polarizers have been used in various kinds of liquid crystal displays such as televisions, personal computers, and mobile phones. Usually, the polarizer is manufactured by dyeing a polyvinyl alcohol (PVA) film and then uniaxially stretching the film. In general, the polarizer is used in the form of a polarizing plate obtained by laminating a protective film (a protective layer) such as a triacetyl cellulose (TAC) film on at least one surface of the polarizer. The moisture content (water content) of the polarizer greatly affects its optical characteristics, adhesiveness, appearance etc. More specific explanation is as follows. The PVA used as the material for forming the polarizer is hydrophilic. However, the PVA is made hydrophobic by the stretching treatment of the polarizer. Owing to this hydrophobization and evaporation of moisture, the moisture content of the polarizer is reduced. A polarizer with a low moisture content exhibits excellent optical characteristics. However, the polarizer with a low moisture content has a low affinity for an aqueous adhesive, so that, for example, the mixing of air occurs during the process of attaching the polarizer to, for example, the protective film, resulting in a poor appearance. In contrast, a polarizer with a high moisture content has a high affinity for an aqueous adhesive, so that the problem of poor appearance is less liable to occur. However, initial optical characteristics of such a polarizer are not very good.

Surface modification methods for a resin product are roughly divided into chemical methods and physical methods. First, for the chemical methods, methods of immersing a resin product in various kinds of liquids, including solutions such as an acid solution, an alkali solution, and a surfactant solution and various kinds of solvents, have been used conventionally. As the physical methods, dry processes such as a method utilizing a corona discharge, an ozone treatment and a plasma treatment have been used (see JP 10(1998)-249271 A, for example).

### SUMMARY OF THE INVENTION

The present invention provides a method of modifying a surface of a polarizer, including the step of irradiating at least one surface of the polarizer with vacuum ultraviolet light.

The present invention also provides a method of manufacturing a polarizer, including the step of: performing a surface modification treatment. In this manufacturing method, the surface modification treatment step is carried out by the above-described surface modification method of the present invention.

The present invention provides a polarizer that has been subjected to a surface modification treatment. The polarizer is manufactured by the above-described manufacturing method of the present invention.

The present invention provides a polarizing plate including a polarizer and a protective layer. The polarizer is the above-described polarizer of the present invention.

The present invention provides an image display apparatus including a polarizing plate. The polarizing plate is the above-described polarizing plate of the present invention.

The present invention provides a liquid crystal panel including a crystal cell and a polarizing plate, in which the polarizing plate is arranged on at least one side of the liquid crystal cell. The polarizing plate is the above-described polarizing plate of the present invention.

Furthermore, the present invention provides a liquid crystal display including a polarizing plate or a liquid crystal panel. The polarizing plate or the liquid crystal panel is the above-described polarizing plate or the liquid crystal panel of the present invention.

### DETAILED DESCRIPTION OF THE INVENTION

When the above-described conventional surface modification methods for a resin product are applied to a polarizer, the following problems arise.

First, according to the chemical method of immersing a polarizer in a solution such as an acid solution, an alkali solution, or a surfactant solution or any of various kinds of solvents, iodine contained in the polarizer is dissolved in the solution or the solvent. If this changes the chemical property of the polarizer, the optical characteristics of the polarizer are significantly deteriorated. In addition, the chemical method requires complicated daily liquid management such as replenishment of volatile components in the solution or the solvent. Moreover, the chemical method also requires securing the safety of the process of handling the liquid. Therefore, according to the chemical method, the manufacturing efficiency of the polarizer is degraded.

Among the physical methods, the method utilizing a corona discharge has a problem in that irregularity is caused in the surface modification degree of the polarizer. Furthermore, in the case where a high-energy corona discharge is used, heat is generated, which may damage the surface of the base material of the polarizer. In the ozone treatment, a low-pressure mercury lamp used as the light source emits not only a light beam having a wavelength of 185 nm, which contributes to ozone generation, but emits also a lot of light beams having other wavelengths. Thus, in the ozone treatment, when a polarizer that absorbs light beams from the visible region to the ultraviolet region is irradiated with the light beams emitted from the light source, undesirable denaturation of the polarizer occurs due to unnecessary light absorption. Therefore, in the ozone treatment, the optical characteristics of the polarizer are deteriorated significantly. Moreover, the plasma treatment needs some time to achieve the desired degree of vacuum. Therefore, it is difficult to incorporate the plasma treatment in an in-line processing, thus posing a problem in productivity.

As described above, the conventional surface modification methods for a resin product cause various problems when applied to a polarizer. On this account, heretofore, it has not been common to perform a surface treatment with respect to a polarizer. Conventionally, a component to be attached to a polarizer, such as a protective film, has been subjected to a surface modification treatment so as to impart hydrophilicity thereto. However, performing the surface modification treatment with respect to the protective film or the like cannot sufficiently improve the adhesiveness.

In order to solve the above-described problems, the inventors of the present invention have conducted a series of studies. In the process of these studies, the inventors of the present invention found that, by irradiating a polarizer with vacuum ultraviolet light, homogenous surface modification could be achieved easily in a short time without impairing the optical characteristics of the polarizer. That is, when a surface of the polarizer is irradiated with vacuum ultraviolet light having a high photon energy, chemical bonds in principal chains and side chains of macromolecules present on the surface of the polarizer are cleaved. At the same time, hydrophilic functional groups are formed on the surface of the polarizer. As a result, the hydrophilicity of the surface of the polarizer is improved. Since the irradiation with the vacuum ultraviolet light can improve the hydrophilicity of the surface of the polarizer even if it is for a short time, the treatment time can be shortened. Additionally, according to the method of the present invention, dirt is not generated by the treatment, so that the method does not require any particular washing step. Thus, the method of the present invention can be carried out in a very simple manner. In addition, the method of the present invention can be carried out with a simple and compact apparatus and thus can be easily incorporated in a production line. Moreover, the method of the present invention consumes a smaller amount of electric power energy than the conventional surface modification methods, and additionally, it does not require an organic solvent or water. Therefore, the method of the present invention is environment-friendly and can be carried out at low cost. A polarizer obtained by the method of the present invention has excellent hydrophilicity, so that mixing of air does not occur when it is attached to a protective layer. Therefore, a polarizing plate according to the present invention is excellent in appearance quality.

In the present invention, “vacuum ultraviolet light” refers to ultraviolet light with relatively short wavelengths. In the conventional art, such short-wavelength ultraviolet light was regarded as incapable of passing through the air and thus was named “vacuum ultraviolet light”. However, in fact, it is possible to irradiate the polarizer surface with the vacuum ultraviolet light by allowing the vacuum ultraviolet light to pass through the air. In the present invention, the wavelength of the vacuum ultraviolet light is not particularly limited, but it is preferably in the range from 0.2 to 200 nm, and is more preferably from 10 to 200 nm. Furthermore, in the surface modification method for a polarizer according to the present invention, it is preferable that the polarizer contains polyvinyl alcohol (PVA) and iodine and that the vacuum ultraviolet light has a wavelength of 180 nm or less. When the polarizer contains PVA and iodine, the PVA absorbs the vacuum ultraviolet light having a wavelength of 180 nm or less, so that a photochemical reaction can be induced easily. Furthermore, when the polarizer contains iodine, absorption caused by iodine (I⁻) appears around a wavelength of 190 nm, so that light absorption caused thereby occurs slightly. However, since macromolecules present on a surface of the polarizer containing the PVA absorb light selectively, light hardly passes through the polarizer in the thickness direction. Therefore, undesirable denaturation of the interior of the polarizer due to unnecessary light absorption does not occur, so that it becomes possible to selectively modify only the outermost surface of the polarizer.

It is to be noted that, in the present invention, unless otherwise indicated, when the scope of the invention is delimited by numerical values, the invention encompasses not only the range strictly delimited by these numerical values but also the range substantially delimited by these numerical values. For example, when the wavelength is “0.2 to 200 nm”, it encompasses not only the case where the wavelength is strictly from 0.2 to 200 nm but also the case where the wavelength is from about 0.2 to about 200 nm.

In the surface modification method for a polarizer according to the present invention, it is preferable that an irradiation energy of the vacuum ultraviolet light is in the range from 10 to 2000 mJ/cm² in view of the efficiency of irradiation. More preferably, the irradiation energy is in the range from 30 to 600 mJ/cm².

In the surface modification method for a polarizer according to the present invention, it is preferable that the irradiation with the vacuum ultraviolet light is performed in an argon atmosphere, in a nitrogen atmosphere, or in the air.

In the surface modification method for a polarizer according to the present invention, it is preferable that a light source of the vacuum ultraviolet light is at least one of an excimer laser and an excimer lamp. The light source has a single luminescence peak with its full width at half maximum being small and has a high photon energy. Therefore, with this light source, the chemical bonds of the polarizer can be cleaved directly in a more efficient manner. Furthermore, with the above-described light source, the undesirable denaturation of the polarizer caused by unnecessary light absorption can be more effectively prevented. Examples of the light source include, for example, an Xe₂ excimer laser, an F₂ excimer laser, a Kr₂ excimer laser, an Ar₂ excimer laser, a harmonic laser using a nonlinear optical device, an Xe₂ excimer lamp, a Kr₂ excimer lamp, and an Ar₂ excimer lamp.

In the surface modification method for a polarizer according to the present invention, it is preferable that the polarizer to be irradiated with the vacuum ultraviolet light has a moisture content of 25 mass % or less.

The polarizer according to the present invention may have, for example, a water contact angle of 30° or less, a surface free energy of at least 65 mJ/cm², and a polarization degree of at least 99.95%.

The polarizing plate according to the present invention may further include a retardation layer. Such a polarizing plate is called an elliptically polarizing plate.

In the following, the present invention will be described in further detail.

As described above, the method of the present invention is a surface modification treatment method for imparting hydrophilicity to at least one surface of a polarizer by irradiating the surface with vacuum ultraviolet light.

As the polarizer to be subjected to the surface modification treatment of the present invention, any suitable polarizer can be selected. Examples of the polarizer include: films obtained by allowing hydrophilic polymer films such as a PVA-based film, a partially-formalized PVA-based film, and a partially-saponified film based on ethylene-vinyl acetate copolymer to adsorb a dichroic substance such as iodine or a dichroic dye, followed by uniaxial stretching; and alignment films based on polyenes such as dehydrated PVA and dehydrochlorinated polyvinyl chloride. Among these, a polarizer obtained by allowing a PVA-based film to adsorb iodine and then uniaxially stretching the film is preferable. The thickness of the polarizer is not particularly limited, and can be, for example, 5 to 80 μm. The moisture content (water content) of the polarizer to be subjected to the surface modification treatment of the present invention (the moisture content before being subjected to the surface modification treatment) is not particularly limited. However, it is preferable that the moisture content is low from the viewpoint of optical characteristics. The moisture content (water content) is, for example, 25 mass % or less, preferably in the range from 10 to 20 mass %, and more preferably in the range from 11 to 15 mass %. In the present invention, the moisture content of the polarizer can be measured by the method described later in the examples, for example.

The polarizer obtained by dyeing a PVA-based film with iodine and then uniaxially stretching the film can be prepared by, for example, dying the PVA-based film with iodine by immersing it in an aqueous solution of iodine and then stretching the film to 3 to 7 times its original length. The aqueous solution of iodine may contain, for example, boric acid, zinc sulfate, or zinc chloride if necessary. Alternatively the PVA-based film may be immersed separately in an aqueous solution containing, for example, boric acid, zinc sulfate, or zinc chloride. Furthermore, if necessary, the PVA-based film may be washed by immersing it in water before dyeing the film. By washing the PVA-based film with water, dirt and an anti-blocking agent on surfaces of the PVA-based film can be cleaned out. Washing the PVA-based film by immersing it in water can bring about another effect that it swells the PVA-based film, thereby preventing nonuniformity such as irregularity in dyeing. The PVA-based film may be stretched after it has been dyed with iodine, or it may be stretched while being dyed with iodine. Alternatively, the PVA-based film may be stretched first and then dyed with iodine. It is possible to stretch the PVA-based film in an aqueous solution of, for example, boric acid or potassium iodide, or in a water bath.

There is no particular limitation on the processing mode of the vacuum ultraviolet light irradiation treatment. For example, in the case of continuous processing, processing using a conveyor is preferable, and in the case of batch processing, processing using a chamber is preferable. Among these, the processing using a conveyor is preferable if the method of the present invention is incorporated in the manufacturing line of the polarizer. Furthermore, one or both surfaces of the polarizer may be irradiated with vacuum ultraviolet light. The surface to be irradiated preferably is a surface to which, for example, a protective layer is to be attached via an adhesive layer.

As described above, examples of a light source of the vacuum ultraviolet light include an Xe₂ excimer laser, an F₂ excimer laser, a Kr₂ excimer laser, an Ar₂ excimer laser, a harmonic laser using a nonlinear optical device, an Xe₂ excimer lamp, a Kr₂ excimer lamp, and an Ar₂ excimer lamp. The wavelength of the vacuum ultraviolet light preferably is 180 nm or less, more preferably is in the range from 12 nm to 180 nm. The irradiation energy of the vacuum ultraviolet light is as described above. The irradiation time of the vacuum ultraviolet light is, for example, in the range from 1 second to 5 minutes, preferably from 1 to 60 seconds, more preferably 3 to 30 seconds, and still more preferably from 5 to 10 seconds.

The shortest distance (irradiation distance) between the surface of the polarizer and the light source preferably is set to 10 mm or less, more preferably 5 mm or less in view of the efficiency of irradiation.

The irradiation environment of the vacuum ultraviolet light is not particularly limited, and can be in an argon atmosphere, in a nitrogen atmosphere, or in the air, for example. According to the method of the present invention, it is not always necessary to perform the irradiation with the vacuum ultraviolet light in a vacuum. Therefore, the method of the present invention can be carried out without using an evacuator.

There is no particular limitation on an irradiation treatment apparatus to be used for the irradiation with vacuum ultraviolet light in the present invention, and commercially available products can be used. Examples of the commercially available products include “UER-172B (trade name)” and “UER-126B (trade name)” manufactured by Ushio Inc.

The polarizer of the present invention can be obtained in the manner described above. The polarizer of the present invention can attain high surface hydrophilicity without impairing the appearance quality, optical characteristics, and homogeneity. In the polarizer according to the present invention, the water contact angle is, for example, 30° or less, preferably 25° or less, and more preferably 15° or less. The surface free energy is, for example, at least 65 mJ/cm², preferably in the range from 70 to 80 mJ/cm². The polarization degree is, for example, at least 99.95%, preferably 99.97% or more. One embodiment of the surface modification method for a polarizer or the method of manufacturing a polarizer according to the present invention is that the optical characteristics of the polarizer are not deteriorated by the surface modification treatment step. The surface modification method for a polarizer or the method of manufacturing a polarizer according to the present invention allows the polarizer to maintain the above-described excellent optical characteristics. Also, according to the surface modification method for a polarizer or the method of manufacturing a polarizer of the present invention, it is possible to modify the polarizer surface so as to have high hydrophilicity as described above. In the present invention, the water contact angle, the surface free energy, and the polarization degree can be measured by the methods described later in the examples, for example.

The polarizing plate according to the present invention may be obtained by attaching a protective layer to at least one surface of the polarizer according to the present invention.

As the protective layer, films that are excellent in transparency, mechanical strength, thermal stability, a moisture shielding property, retardation value stability etc. are preferable. Examples of the material for forming the protective layer include: polyester resins such as polyethylene terephthalate and polyethylene naphthalate; cellulose resins such as diacetyl cellulose and triacetyl cellulose (TAC); acrylic resins such as polymethyl methacrylate; styrene resins such as polystyrene, acrylonitrile-butadiene-styrene resin, acrylonitrile-ethylene-styrene resin, styrene-maleimide copolymer, and styrene-maleic anhydride copolymer; and polycarbonate resins. In addition, other examples of the material for forming the protective layer include: polyolefin resins such as cyclo olefin resins, norbornene resins, polyethylene, polypropylene, and ethylene-propylene copolymer; vinyl chloride resins; amide resins such as nylon and aromatic polyamide; imide resins such as aromatic polyimide and polyimide amide; sulfone resins; polyethersulfone resins; polyetheretherketone resins; polyphenylene sulfide resins; vinyl alcohol resins; vinylidene chloride resins; vinyl butyral resins; arylate resins; polyoxymethylene resins; epoxy resins; and polymer films formed of mixtures of two or more kinds of the above-described resins.

As the polymer films, those described in JP 2001-343529 A and WO 01/37007 can be used, for example. Specific examples of the polymer films include polymer films containing (A) a thermoplastic resin whose side chain has at least one of a substituted imido group and an unsubstituted imido group and (B) a thermoplastic resin whose side chain has a nitrile group and at least one of a substituted phenyl group and an unsubstituted phenyl group. More specifically, polymer films containing a copolymer of isobutene and N-methyl maleimide and an acrylonitrile-styrene copolymer can be used, for example.

As the protective layer, it is preferable to use a cellulose resin film such as a TAC film or a norbornene resin film from the viewpoint of a polarization property, durability etc. Specific examples thereof include “FUJITAC (trade name)” manufactured by Fuji Photo Film Co., Ltd., “ZEONOR (trade name)” manufactured by ZEON CORPORATION, and “ARTON (trade name)” manufactured by JSR CORPORATION.

The thickness of the protective layer can be determined as appropriate, but is, for example, in the range from 1 μm to 500 μm, preferably from 5 μm to 200 μm, and more preferably from 10 μm to 150 μm, from the viewpoint of workability such as strength and handleability, thickness reduction etc.

The attachment of the polarizer of the present invention and the protective layer can be achieved by, for example, attaching them to each other using an adhesive. The wettability (hydrophilicity) of the surface of the polarizer of the present invention has been improved by the above-described surface modification treatment. Therefore, when attaching the polarizer of the present invention and the protective layer to each other, the generation of air bubbles etc. caused by the mixing of air is prevented from occurring.

Although there is no particularly limitation on the adhesive, it is preferable to use an adhesive with high polarity from the aspects of prevention of the generation of air bubbles etc. The adhesive with high polarity can be an adhesive composed of an acrylic polymer or a vinyl alcohol polymer, for example. The adhesive composed of a vinyl alcohol polymer is preferable from the viewpoint of adhesion strength with the polarizer. The adhesive may contain a water-soluble crosslinking agent for a vinyl alcohol polymer, such as boric acid, borax, glutaraldehyde, melamine, or oxalic acid, for example.

Some adhesives can attain improved adhesion strength when used in combination with a suitable adhesion-improving undercoat. When using such adhesives, it is preferable to use the adhesion-improving undercoat.

The adhesion-improving undercoat is not particularly limited as long as it can improve the adhesion strength. Examples of the adhesion-improving undercoat include: coupling agents such as a silane coupling agent having a reactive functional group such as an amino group, a vinyl group, an epoxy group, a mercapto group, or a chloro group and a hydrolyzable alkoxysilyl group within the same molecule, a titanate coupling agent having a titanium-containing hydrolyzable hydrophilic group and an organic functional group within the same molecule, and an aluminate coupling agent having an aluminum-containing hydrolyzable hydrophilic group and an organic functional group within the same molecule; and resins having an organic reactive group, such as epoxy resins, isocyanate resins, urethane resins, and ester-urethane resins. Among these, it is preferable to use a silane coupling agent on the ground that it can be handled easily from the industrial point of view.

The polarizing plate according to the present invention may further include a retardation layer. The retardation layer is arranged on at least one surface of the laminate of the polarizer of the present invention and the protective layer (this laminate is the polarizing plate).

The retardation layer can be formed by attaching, e.g., a thermoplastic resin film having retardation to the polarizing plate via an adhesive layer. The thermoplastic resin is not particularly limited, and examples thereof include norbornene resins, cellulose resins, polyamide resins, polycarbonate resins, polysulfone resins, polyethersulfone resins, polyetheretherketone resins, polyarylate resins, polyamide-imide resins, polyimide resins, and acrylic resins. These thermoplastic resins can be used alone or in combination of at least two kinds thereof. Furthermore, as the adhesive for forming the adhesive layer, those described above as usable when attaching the polarizer and the protective layer can be used, for example.

The polarizing plate of the present invention can be used preferably in various image display apparatuses such as liquid crystal displays (LCDs) and EL display (ELDs). The configuration of the liquid crystal display of the present invention is not particularly limited as long as it includes the polarizing plate of the present invention or the liquid crystal panel of the present invention, and it may have the same configuration as those of conventional liquid crystal displays, for example. The liquid crystal display of the present invention can be manufactured by appropriately assembling respective components, namely optical elements such as a liquid crystal cell and the polarizing plate of the present invention and, as necessary, a lighting system (a backlight etc.), and then incorporating a driving circuit, for example.

In the present invention, the configuration of the liquid crystal display is not particularly limited. For example, the liquid crystal display of the present invention can be a liquid crystal display configured so that an optical element such as the polarizing plate of the present invention is arranged on at least one side of a liquid crystal cell, or can be a liquid crystal display in which a backlight or a reflection plate is used in a lighting system. When optical elements such as the polarizing plate of the present invention are arranged on both sides of the liquid crystal cell, they may be the same or different. Furthermore, in the liquid crystal display of the present invention, optical elements and optical components such as a diffusion plate, an anti-glare layer, an antireflection layer, a protective plate, a prism array, and a lens array sheet may be arranged, for example.

The image display apparatus of the present invention is applicable to any suitable use. Examples of the use thereof include: office automation equipment such as desktop computers, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing care monitors and medical monitors.

### EXAMPLES

Examples of the present invention will be described together with comparative examples. It is to be noted, however, the present invention is by no means limited to or restricted by the following examples and comparative examples. The measurement and evaluation of various characteristics and physical properties described in the respective examples and comparative examples were carried out by the following methods.

### (1) Water Contact Angle

The water contact angle was measured using a contact angle meter (Kyowa Interface Science Co., Ltd., trade name “CA-X type”, image processing type, three-component surface energy analysis). Specifically, the water contact angle was determined by dripping water on a polarizer and observing the water droplet with the contact angle meter.

### (2) Surface Free Energy

The surface free energy was calculated using the contact angle meter (Kyowa Interface Science Co., Ltd., trade name “CA-X type”, image processing type, three-component surface energy analysis). Specifically, first, water, diiodomethane, and bromonaphthalene were dripped on a polarizer, and the respective liquid droplets were observed with the contact angle meter to determine the contact angles. Then, based on the thus-determined contact angles, the surface free energy was calculated automatically using a program installed on the contact angle meter.

### (3) Polarization Degree (P)

The polarization degree (P) of a polarizer was determined by measuring a first principal transmittance (k1) and a second principal transmittance (k2) of the polarizer using a spectrophotometer (JASCO Corporation, trade name “V7100”) and substituting the thus-measured transmittances to the following equation. Note here that the first principal transmittance (k1) is a transmittance of the polarizer obtained when linearly polarized light perpendicular to the absorption axis of the polarizer enters the polarizer, and the second principal transmittance (k2) is a transmittance of the polarizer obtained when linearly polarized light parallel to the absorption axis of the polarizer enters the polarizer.

Polarization degree (%)={(k1−k2)/(k1+k2)}×100

### (4) Moisture Content

The moisture content was calculated by measuring the masses (weights) of a polarizer before and after a drying treatment and then substituting the thus-measured masses (weights) into the following equation. The drying treatment was performed by heat drying the polarizer at 120° C. for at least 2 hours.

Moisture content (mass %)=[Wb/(Wb−Wa)]×100
Wb: The mass (g) of the polarizer before being subjected to the drying treatment.
Wa: The mass (g) of the polarizer after being subjected to the drying treatment.

### Example 1

A polarizer manufactured by allowing a polyvinyl alcohol (PVA) film to adsorb iodine and then uniaxially stretching the film (with a thickness of 32 μm and a moisture content of 15 mass %) was set in a vacuum ultraviolet light irradiation treatment apparatus (Ushio Inc., trade name “UER-172B”). Nitrogen gas was supplied to the apparatus for 2 minutes to remove the oxygen in the apparatus. Then, both surfaces of the polarizer were irradiated with vacuum ultraviolet light having a wavelength of 172 nm, which was emitted from an Xe excimer lamp, with an irradiation energy of 100 mJ/cm² (for 10 seconds at an intensity of 10 mW/cm²). Thus, a polarizer of the present example was obtained.

The contact angle of water on the surface of the polarizer of the present example was 26°, and the surface free energy was 69 mJ/cm². The polarization degree of the polarizer of the present example was 99.96%.

Two protective layers were attached to the polarizer under the following conditions, thus obtaining a polarizing plate.

### (Conditions)

(1) The protective layers: TAC films
(2) Adhesive: water-soluble adhesive composed of vinyl alcohol polymer
(3) Attachment method: The polarizer was sandwiched between the two protective layers, and the adhesive was supplied between each of the protective layers and the polarizer. Thereafter, the respective protective layers and the polarizer were attached using a compact-size laminating machine.
(4) Drying condition: at 60° C. for 5 minutes

The appearance of the polarizing plate was evaluated through visual observation. As a result, it was found that no mixing of air occurred between the polarizer and the protective layers.

### Example 2

A polarizer of the present example was obtained in the same manner as in Example 1, except that the irradiation energy of the vacuum ultraviolet light was set to 600 mJ/cm². The contact angle of water on a surface of the polarizer of the present example was 9.4°, and the surface free energy was 74 mJ/cm². The polarization degree of the polarizer of the present example was 99.98%. Protective layers were attached to this polarizer in the same manner as in Example 1, thus obtaining a polarizing plate. The polarizing plate was observed visually. As a result, it was found that no mixing of air occurred between the polarizer and the protective layers.

### Example 3

A polarizer of the present example was obtained in the same manner as in Example 1, except that both surface of the polarizer were irradiated with vacuum ultraviolet light having a wavelength of 126 nm, which was emitted from an Xe excimer lamp, using a vacuum ultraviolet light irradiation treatment apparatus (Ushio Inc., trade name “UER-126B”). The contact angle of water on the surface of the polarizer of the present example was 8.6°, and the surface free energy was 74 mJ/cm². The polarization degree of the polarizer of the present example was 99.98%. Protective layers were attached to this polarizer in the same manner as in Example 1, thus obtaining a polarizing plate. The polarizing plate was observed visually. As a result, it was found that no mixing of air occurred between the polarizer and the protective layers.

### Example 4

A polarizer of the present example was obtained in the same manner as in Example 1, except that the irradiation energy of the vacuum ultraviolet light was set to 2000 mJ/cm². The contact angle of water on a surface of the polarizer of the present example was 25°, and the surface free energy was 69 mJ/cm². The polarization degree of the polarizer of the present example was 99.98%. Protective layers were attached to this polarizer in the same manner as in Example 1, thus obtaining a polarizing plate. The polarizing plate was observed visually. As a result, it was found that no mixing of air occurred between the polarizer and the protective layers.

### Example 5

A polarizer of the present example was obtained in the same manner as in Example 1, except that the irradiation with the vacuum ultraviolet light was performed not in the nitrogen atmosphere but in the air. The contact angle of water on a surface of the polarizer of the present example was 13°, and the surface free energy was 73 mJ/cm². The polarization degree of the polarizer of the present example was 99.98%. Protective layers were attached to this polarizer in the same manner as in Example 1, thus obtaining a polarizing plate. The polarizing plate was observed visually. As a result, it was found that no mixing of air occurred between the polarizer and the protective layers.

### Comparative Example 1

The polarizer of Example 1 before being subjected to the irradiation with the vacuum ultraviolet light was used as a polarizer of the present comparative example. The contact angle of water on a surface of the polarizer of the present comparative example was 58°, and the surface free energy was 53 mJ/cm². The polarization degree of the polarizer of the present comparative example was 99.97%. Protective layers were attached to this polarizer in the same manner as in Example 1, thus obtaining a polarizing plate. The polarizing plate was observed visually. As a result, it was found that mixing of air occurred between the polarizer and the protective layers.

### Comparative Example 2

A polarizer of the present comparative example was obtained in the same manner as in Example 1, except that both surfaces of the polarizer were irradiated with ultraviolet light having a wavelength of 222 nm, which was emitted from an Xe excimer lamp. The contact angle of water on a surface of the polarizer of the present comparative example was 53°, and the surface free energy was 55 mJ/cm². The polarization degree of the polarizer of the present example was 99.98%. Protective layers were attached to this polarizer in the same manner as in Example 1, thus obtaining a polarizing plate. The polarizing plate was observed visually. As a result, it was found that mixing of air occurred between the polarizer and the protective layers.

TABLE 1

| | Ultraviolet | Ultraviolet | Water | Surface | Polari- | |
|---|---|---|---|---|---|---|
| | wave- | irradiation | contact | free | zation | |
| | length | energy | angle | energy | degree | Mixing |
| | (nm) | (mJ/cm²) | (°) | (mJ/cm²) | (%) | of air |
| Ex. 1 | 172 | 100 | 26 | 69 | 99.96 | none |
| Ex. 2 | 172 | 600 | 9.4 | 74 | 99.98 | none |
| Ex. 3 | 126 | 100 | 8.6 | 74 | 99.98 | none |
| Ex. 4 | 172 | 2000 | 25 | 69 | 99.98 | none |
| Ex. 5 | 172 | 100 | 13 | 73 | 99.98 | none |
| Comp. | — | — | 58 | 53 | 99.97 | present |
| Ex. 1 | | | | | | |
| Comp. | 222 | 100 | 53 | 55 | 99.98 | present |
| Ex. 2 | | | | | | |

As specifically described above, according to the present invention, hydrophilicity of a surface of a polarizer can be improved uniformly in a short time through a simple operation without impairing the optical characteristics of the polarizer. Examples of the use of the polarizer of the present invention and the polarizing plate, image display apparatus, liquid crystal panel, and liquid crystal display using the same include: office automation equipment such as desktop computers, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing care monitors and medical monitors. There is no limitation on the use thereof, and they are applicable to a wide range of fields.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A method of modifying a surface of a polarizer, the method comprising the step of:
irradiating at least one surface of the polarizer with vacuum ultraviolet light.

2. The method according to claim 1, wherein the vacuum ultraviolet light has a wavelength of 200 nm or less.

3. The method according to claim 1, wherein the polarizer contains polyvinyl alcohol and iodine, and the vacuum ultraviolet light has a wavelength of 180 nm or less.

4. The method according to claim 1, wherein an irradiation energy of the vacuum ultraviolet light is in a range from 10 to 2000 mJ/cm².

5. The method according to claim 1, wherein the irradiation with the vacuum ultraviolet light is performed in an argon atmosphere, in a nitrogen atmosphere, or in the air.

6. The method according to claim 1, wherein a light source of the vacuum ultraviolet light is at least one selected from the group consisting of an Xe₂ excimer laser, an F₂ excimer laser, a Kr₂ excimer laser, an Ar₂ excimer laser, a harmonic laser using a nonlinear optical device, an Xe₂ excimer lamp, a Kr₂ excimer lamp, and an Ar₂ excimer lamp.

7. The method according to claim 1, wherein the polarizer to be irradiated with the vacuum ultraviolet light has a moisture content of 25 mass % or less.

8. A method of manufacturing a polarizer, the method comprising the step of:
performing a surface modification treatment,
wherein the surface modification treatment step is carried out by the method according to claim 1.

9. A polarizer that has been subjected to a surface modification treatment, which is manufactured by the method according to claim 8.

10. The polarizer according to claim 9, which has a water contact angle of 30° or less, a surface free energy of at least 65 mJ/cm², and a polarization degree of at least 99.95%.

11. A polarizing plate comprising a polarizer and a protective layer, wherein the polarizer is the polarizer according to claim 9.

12. The polarizing plate according to claim 11, further comprising a retardation layer.

13. An image display apparatus comprising a polarizing plate, wherein the polarizing plate is the polarizing plate according to claim 11.

14. A liquid crystal panel comprising a liquid crystal cell and a polarizing plate, the polarizing plate being arranged on at least one side of the liquid crystal cell, wherein the polarizing plate is the polarizing plate according to claim 11.

15. A liquid crystal display comprising a polarizing plate, wherein the polarizing plate is the polarizing plate according to claim 11.

16. A liquid crystal display comprising a liquid crystal panel, wherein the liquid crystal panel is the liquid crystal panel according to claim 14.
